(19) United States
(12) Patent Application Publication
(10) Pub. No.: US 2006/0095842 A1
(43) Pub. Date: May 4, 2006

(54) Word completion dictionary

(75) Inventor: Julia Lehto, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/978,598

(22) Filed: Nov. 1, 2004

(51) Int. Cl. G06F 17/24; G06F 17/00

(52) U.S. Cl. 715/532

(57) ABSTRACT

A device, a computer program, and a method provide a word completion dictionary capable of editing by a user. The computer program includes computer code configured to present a word completion dictionary and to present a dictionary editing option. The word completion dictionary includes a plurality of words that may be selected while entering text in a text entry application. The dictionary editing option allows the user to modify the word completion dictionary. Dictionary editing options include, but are not limited to, add, delete, edit, mark, and unmark.

### FIELD OF THE INVENTION

The present invention is related to text entry applications. More specifically, the present invention relates to the predictive input of text into text entry applications and the editing of the word completion dictionary.

### BACKGROUND OF THE INVENTION

Mobile device communication capabilities, in addition to supporting voice conversations with other phones, now increasingly include a variety of text messaging technologies previously available in personal computers (PCs). Text messaging technologies include e-mail, Instant Messaging (IM), facsimile, short messaging, and multimedia messaging. Short messaging and multimedia messaging are hybrids of e-mail and IM. The Short Messaging Service (SMS) is a store and forward method of transmitting short messages to and from mobiles devices. SMS can also be used to transmit e-mail and IM messages. The Multimedia Messaging Service (MMS) transmits messages to and from mobile communication devices in a store-and-forward manner much like SMS, but MMS allows a combination of text, sounds, images, and video.

Communication devices now also communicate with other types of devices such as computers of all form factors, Personal Digital Assistants (PDAs) or handheld PCs, Integrated Communication Devices (ICDs), etc. Additionally, communication devices have merged the capabilities of cellular telephones, PDAs, ICDs, and computing devices and now provide increasingly sophisticated applications. Applications provide the communication device with the ability to perform a wide variety of tasks including drafting documents, preparing presentations, creating movies and music, taking pictures, maintaining schedules, etc. Most applications require text entry by the user.

Communication devices generally are small and lightweight because the desire is for an easily portable device. As a result, the display and the input areas are small and generally more tedious to use. Some devices may have a small keyboard provided, while others provide a pen and touch interface. Use of the pen and touch interface may entail use of an on-screen keyboard such that the user “types” by selecting each letter from the on-screen keyboard with a pen or stylus. Alternatively, a pen and touch interface may entail use of a tablet on which the user “writes.” The devices may or may not include a mouse, a track ball, or other buttons to facilitate input to the device. Some devices, such as cellular telephones, have a numerical keypad that include multiple alphabetic letters assigned to a single number on the keypad. Text entry with keypads generally requires a time lapse as the user sequences through the alphabetic letters assigned to each number to select the desired character. As a result, text entry is time consuming and tedious. Thus, there is a need to reduce the amount of text entry required for text entry applications such as text editors and text messaging applications, particularly in communication devices.

European Patent Application No. 02026156.6 and U.S. patent application Ser. No. 993,513, assigned to the assignee of the present invention and incorporated herein by reference, describe a communication device with a text editor application having a word completion feature. As a user of the text editor enters text, the text editor matches words in a dictionary having the same sequence of text entries. The user can then select the desired matching word displayed to the user from the dictionary without entering the text of the entire word. As a result, the task of entering text is significantly reduced. The user may add a word to the dictionary by selecting a word typed into the text editor. When the memory allocated to the dictionary is exceeded, the least used words stored in the dictionary are deleted and replaced with new words. One problem relative to storing the words is that misspelled words that are accidentally included in the dictionary are also stored to the memory. When the user attempts to type in the word later, the incorrect word may be repeatedly provided by the dictionary. What is needed, therefore, is a device that allows for the correction of misspelled words in the word completion dictionary.

### SUMMARY OF THE INVENTION

An exemplary embodiment of the invention relates to a method of modifying a word completion dictionary. The method includes, but is not limited to, presenting a word completion dictionary and presenting a dictionary editing option. The word completion dictionary includes a plurality of words that may be selected while entering text in a text entry application. Selection of the dictionary editing option allows a user to modify the word completion dictionary.

Another exemplary embodiment of the invention relates to a computer program for modifying a word completion dictionary. The computer program includes computer code configured to present a word completion dictionary and to present a dictionary editing option. Selection of the dictionary editing option allows a user to modify the word completion dictionary. The word completion dictionary includes a plurality of words that may be selected while entering text in a text entry application.

Still another exemplary embodiment of the invention relates to a device that allows modification of a word completion dictionary. The device includes a word completion dictionary, a display, an input interface, a memory, and a processor. The word completion dictionary comprises computer code configured to present a plurality of words that may be selected while entering text in a text entry application and to present a dictionary editing option. The display presents a user interface to the word completion dictionary. The input interface is configured to allow a user to select the dictionary editing option, wherein selection of the dictionary editing option allows the user to modify the word completion dictionary. The memory stores the word completion dictionary. The processor couples to the memory and executes the word completion dictionary.

Another embodiment relates to a method of providing a word for entry in a text entry application using a word completion dictionary. The method can include recording a sequence of text entries as a user enters a word in a text entry application, comparing the sequence of text entries to a plurality of words stored in a word completion dictionary, selecting one or more matching words from the word completion dictionary, and displaying the one or more matching words to the user. The word completion dictionary can includes a dictionary editing option, and selection of the dictionary editing option by the user can be configured to allow the user to modify one or more of the plurality of words stored in the word completion dictionary. In one embodiment, the matching words can have the same sequence of text entries.

Still another embodiment of the invention relates to a computer program for providing a word for entry in a text entry application using a word completion dictionary. The computer program can include computer code configured to record a sequence of text entries as a user enters a word in a text entry application, compare the sequence of text entries to a plurality of words stored in a word completion dictionary, select one or more matching words from the word completion dictionary, and display the one or more matching words to the user. The word completion dictionary can include a dictionary editing option, wherein selection of the dictionary editing option by the user allows the user to modify one or more of the plurality of words stored in the word completion dictionary. In one embodiment, the matching words can have the same sequence of text entries.

Another embodiment of the invention can include a device for providing a word for entry in a text entry application using a word completion dictionary. The device can comprise a word completion dictionary, the word completion dictionary comprising computer code configured to display a plurality of words selectable by a user while entering text in a text entry application and allow the user to select a dictionary editing option. A word completion utility can also be included. The word completion utility can comprise computer code configured to record a sequence of text entries as the user enters a word in the text entry application, compare the sequence of text entries to a plurality of words stored in the word completion dictionary, select one or more matching words from the word completion dictionary, and display the one or more matching words to the user. In one embodiment, the matching words have the same sequence of text entries. A display, an input interface, a memory, and a processor can also be included. The display can present the user with a view of a user interface to the word completion dictionary and with a view of a user interface to the word completion utility. The input interface can be configured to allow the user to select the dictionary editing option, wherein selection of the dictionary editing option allows the user to modify the word completion dictionary, allow the user to enter text in the word completion dictionary, and allow the user to select a matching word from the one or more matching words displayed to the user. The memory can be configured to store the word completion dictionary and the word completion utility. The processor can be configured to execute the word completion dictionary and the word completion

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of a system in accordance with an exemplary embodiment.

FIG. 2 is a block diagram of a device in accordance with an exemplary embodiment.

FIG. 3 is a first user interface window of the word completion dictionary in accordance with an exemplary embodiment.

FIG. 4 is a second user interface window depicting the editing options of the word completion dictionary in accordance with an exemplary embodiment.

FIG. 5 is a third user interface window depicting the editing function of the word completion dictionary in accordance with an exemplary embodiment.

### DETAILED DESCRIPTION OF THE INVENTION

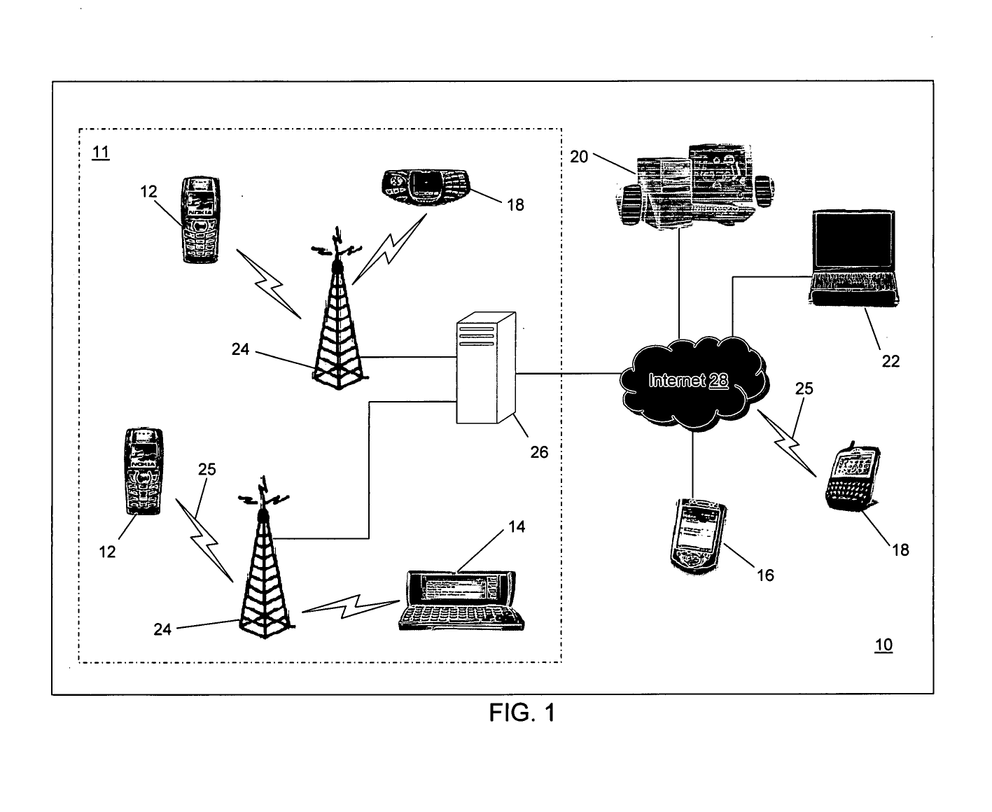

With reference to FIG. 1, the system 10 is comprised of multiple communication devices that can communicate through a network. The system 10 may comprise any combination of wired or wireless networks including, but not limited to, a cellular telephone network, a wireless Local Area Network (LAN), a Bluetooth personal area network, an Ethernet LAN, a token ring LAN, a wide area network, the Internet, etc. The system 10 may include both wired and wireless communication devices. For exemplification, the system 10 shown in FIG. 1 includes a cellular telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of system 10 may include, but are not limited to, a cellular telephone 12, a combination PDA and cellular telephone 14, a PDA 16, an ICD 18, a desktop computer 20, and a notebook computer 22. The communication devices may send and receive calls and messages and communicate with service providers through a wireless connection 25 to a base station 24. The base station 24 may be connected to a network server 26 that allows communication between the cellular telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

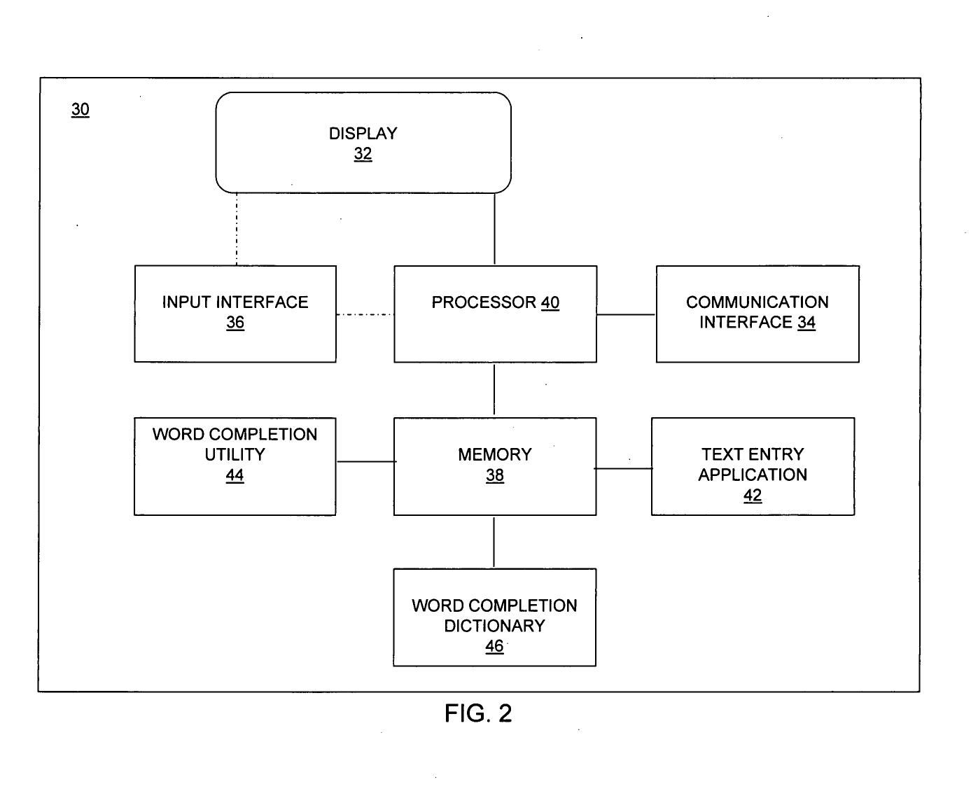

In an exemplary embodiment, the communication device 30, as shown in FIG. 2, may include, but is not limited to, a display 32, a communication interface 34, an input interface 36, a memory 38, a processor 40, a text entry application 42, a word completion utility 44, and a word completion dictionary 46. Different and additional components of communication device 30 may be incorporated into the communication device 30 and/or the system 10. Additionally, the device 30 need not include all of the components depicted in FIG. 2. The components of device 30 may be embodied in any of the cellular telephone 12, the combination PDA and cellular telephone 14, the PDA 16, the ICD 18, the desktop computer 20, the notebook computer 22, etc.

The display 32 presents information to a user. The display 32 may be, but is not limited to, a thin film transistor (TFT) display, a light emitting diode (LED) display, a Liquid Crystal Display (LCD), a Cathode Ray Tube (CRT) display, etc.

The communication interface 34 provides an interface for receiving and transmitting calls, messages, and any other information communicable between devices. The communication interface 34 may use various transmission technologies including, but not limited to, CDMA, GSM, UMTS, TDMA, TCP/IP, SMS, MMS, e-mail, IMS, Bluetooth, IEEE 802.11, etc. to transfer content to and from the device 30.

The input interface 36 provides an interface for receiving information from the user for entry into the device 30. The input interface 36 may use various input technologies including, but not limited to, a keyboard, a pen and touch screen, a mouse, a track ball, a touch screen, a keypad, one or more buttons, etc. to allow the user to enter information into the device 30 or to make selections. The input interface 36 may provide both an input and an output interface. For example, a touch screen both allows user input and presents output to the user.

The memory 38 is the electronic holding place for the operating system, the text entry application 42, the word completion utility 44, and the word completion dictionary 46, other applications, and/or data so that the information can be reached quickly by the processor 40. The device may have a plurality of memories 38 using different memory technologies including, but not limited to, Random Access Memory (RAM), Read Only Memory (ROM), flash memory, etc. The data in RAM is volatile meaning that it remains only as long as the device is turned on. When the device is turned off, RAM loses its data. The values stored in ROM are always there, whether the device is on or not. Flash memory is a type of constantly-powered non-volatile memory that can be erased and reprogrammed in units of memory called blocks.

The processor 40 may retrieve a set of instructions such as the text entry application 42, the word completion utility 44, and the word completion dictionary 46 from a non-volatile or a permanent memory and copy the instructions in an executable form to a temporary memory. The temporary memory is generally some form of RAM. The processor 40 executes an application or a utility, meaning that it performs the operations called for by that instruction set. The processor 40 may be implemented as a special purpose computer, logic circuits, hardware circuits, etc. Thus, the processor 40 may be implemented in hardware, firmware, software, or any combination of these methods.

The text entry application 42, the word completion utility 44, and the word completion dictionary 46, the operating system, and any other applications may be executed by the same processor 40. Alternatively, the text entry application 42, the word completion utility 44, and the word completion dictionary 46, the operating system, and any other applications may be executed by different processors. The text entry application 42, the word completion utility 44, and the word completion dictionary 46, the operating system, and other applications may be written in the same or different computer languages including, but not limited to high level languages, scripting languages, assembly languages, etc.

The text entry application 42 is an organized set of instructions that, when executed, cause the communication device 30 to behave in a predetermined manner. The text entry application 42 may include, but is not limited to, a word processor application, a spreadsheet application, a presentation tool application, a video player/recorder application, an audio player/recorder application, an image editor/viewer application, an Internet browser application, a directory file system browser application, a messaging application such as an e-mail, an instant messaging, an SMS, an MMS, or a facsimile application, a scheduling application, a contacts application, etc. The instructions may be written using one or more programming languages, assembly languages, scripting languages, etc.

Predictive text entry allows a user to enter text by pressing only one key per letter. As a word is entered, the device automatically compares all of the possible letter combinations against a dictionary of words and determines the possible alternative words that a user may be in the process of entering. The predictive text entry algorithm may select the wrong word, but allow the user to select from other possible words without requiring the user to re-enter the word. Thus, predictive text entry generally provides a word completion functionality that consists of completing a word when the user has entered only a part of the word. The text may be any character including numbers, symbols, various alphabetic characters, etc. In an alternative text entry method, after the whole word has been entered, the device automatically suggests a word. Additionally, the device allows the user to browse the possible alternatives with that letter combination. As a result, there are at least three methods for text entry completion: 1) the word is entered completely and alternatives can be browsed after the word is complete, 2) as the word is being entered, the device provides alternative words to complete the word currently being entered, or 3) both text entry completion methods are provided.

The word completion utility 44 is an organized set of instructions that, when executed, provide the word completion function that saves the user from entering the entire word into a text entry application. The instructions may be written using one or more programming languages, assembly languages, scripting languages, etc. The word completion utility 44 may interface with, but is not limited to, interfacing with the text entry application 42. The word completion utility 44 records a sequence of text entries by a user as the user enters a word in the text entry application 42. With each text entry, the word completion utility 44 compares the sequence of text entries to a plurality of words stored in the word completion dictionary 46. The word completion utility 44 selects one or More matching words from the word completion dictionary 46. The matching words have the same sequence of text entries as entered by the user. As known to those skilled in the art, various algorithms may be used to select and to order the matching words. The word completion utility 44 displays the one or more matching words to the user as the user enters the word in the text entry application 42. The user can select from the displayed words to complete entry of the word in the text entry application 42.

The word completion dictionary 46 is an organized set of instructions that, when executed, provide the word completion utility 44 with one or more words that may be matched to the sequence of text entries. The instructions may be written using one or more programming languages, assembly languages, scripting languages, etc. The word completion dictionary 46, in an exemplary embodiment, may provide a user interface that allows the user to view and to select from items stored by the word completion dictionary 46. The display 32 presents the user interface of the word completion dictionary 46 to the user. The input interface 36 allows the user to select from various items presented in the user interface of the word completion dictionary 46 and to enter text into the word completion interface.

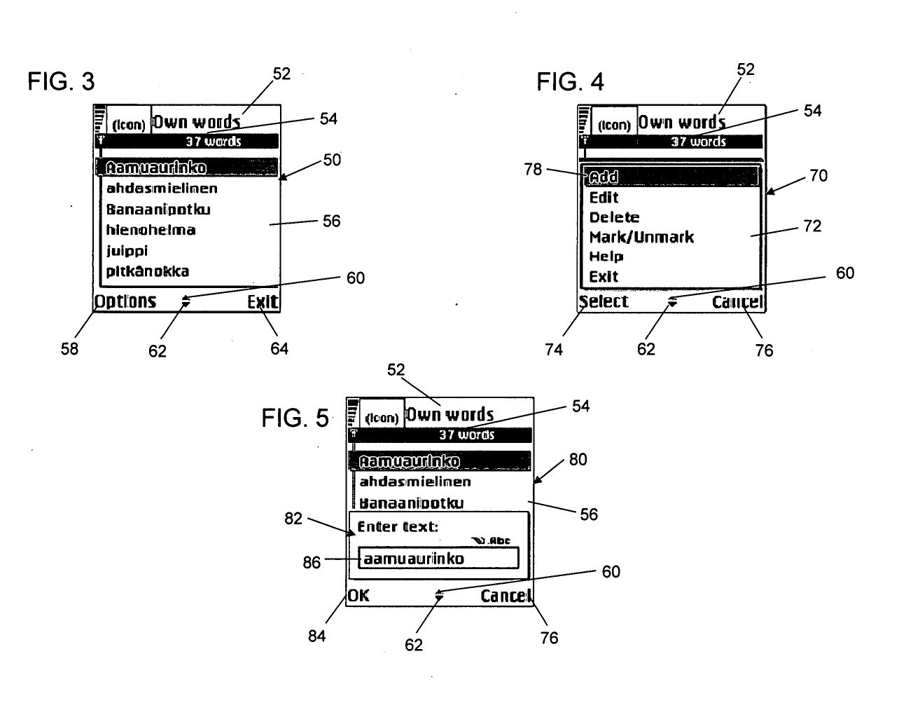

With reference to FIG. 3, a first user interface window 50 includes, but is not limited to, a title bar 52, a dictionary word count 54, a dictionary word list 56, a dictionary editing option button 58, a scroll up button 60, a scroll down button 62, and an exit button 64. The title bar 52 may display the name of the word completion dictionary 46. The dictionary word count 54 may display the number of words stored by the word completion dictionary 46. The dictionary word list 56 contains a plurality of words that the word completion utility may select from in matching a word the user is entering in the text entry application 42. The scroll up button 60 and the scroll down button 62 may allow the user to move up and down within the dictionary word list 56. The selected word 66 in the dictionary word list 56 may be changed using the scroll up button 60 and the scroll down button 62. The user may select the exit button 64 to exit the first user interface window 50 thereby closing the word completion dictionary 46.

Selection of the dictionary editing option button 58 by the user using the input interface 36 may cause the display 32 to present a second user interface window 70. The second user interface window 70 may include, but is not limited to, the title bar 52, the dictionary word count 54, the scroll up button 60, the scroll down button 62, an editing option list 72, a select button 74, and a cancel button 76. The editing option list 72 provides editing options to the user. Example editing options include, but are not limited to, add, edit, delete, mark, and unmark. The editing option “add” allows the user to add a new word to the dictionary word list 56. The editing option “edit” allows the user to modify a selected word in the dictionary word list 56. For example, the user may want to correct a word that is misspelled in the dictionary word list 56. The editing option “delete” allows the user to delete a selected word from the dictionary word list 56. The editing option “mark/unmark” provides for a group editing option. For example, if one or more word is marked, and the delete option is selected, all of the “marked” words are deleted. Successive selection of the “mark/unmark” editing option allows the user to mark and then possibly to unmark the word. The editing option list 72 may additionally include a help option that provides information to the user concerning use of the word completion dictionary 46 and an exit option to exit the editing option list 72 and/or exit the entire word completion application. The selected editing option 78 in the editing option list 72 may be changed using the scroll up button 60 and the scroll down button 62. The user may select the select button 74 to execute the selected editing option 78. The user may select the cancel button 76 to exit the second user interface window 70 thereby returning to the first user interface window 50.

Selection of the select button 74 by the user using the input interface 36 may cause the display 32 to present a third user interface window 80 if, for example, the editing option add or edit is the selected editing option 78. The third user interface window 80 may include, but is not limited to, the title bar 52, the dictionary word count 54, the dictionary word list 56, the scroll up button 60, the scroll down button 62, the cancel button 76, a text entry window 82, and an OK button 84. The text entry window 82 includes, but is not limited to, a text entry box 86. The user enters the new word or the edited word in the text entry box 86. To save the new or edited word to the dictionary word list 56, the user selects the OK button 84. The user may select the cancel button 76 to exit the third user interface window 80 thereby returning to the first user interface window 50.

The word completion dictionary 46 may exclude words provided automatically. In this way, the user is able to see the words added by him/herself or other users of the device. Alternatively, the word completion dictionary 46 may include words provided automatically to the user, but the words added by the user to the word completion dictionary 46 may be highlighted, indicated in bold font, indicated using a color font, etc. In this way the user is also able to see the words that are already in the dictionary and possibly also edit automatically provided words. There may also be a search function for searching specific words.. The editing option list 72 may additionally include an option to specify how the words added by the user to the word completion dictionary 46 are indicated. Selection of the option allows the user to select a method of indicating a word added to the word completion dictionary by the user.

The described invention provides a method and a device for editing and for viewing a word completion dictionary. As a result, a more efficient and more correct word completion dictionary may be maintained at a device. It is understood that the invention is not confined to the particular embodiments set forth herein as illustrative, but embraces all such modifications, combinations, and permutations as come within the scope of the following claims. Thus, the description of the exemplary embodiments is for purposes of illustration and not limitation.

What is claimed is:

1. A method of modifying a word completion dictionary, the method comprising:
presenting a word completion dictionary, wherein the word completion dictionary includes a plurality of words that may be selected while entering text in a text entry application; and
presenting a dictionary editing option, wherein selection of the dictionary editing option allows a user to modify the word completion dictionary.

2. The method of claim 1, further comprising selecting a word from the plurality of words in the word completion dictionary.

3. The method of claim 2, wherein the dictionary editing option is an option selected from the group consisting of delete, edit, mark, and unmark.

4. The method of claim 1, wherein the dictionary editing option adds a new word to the plurality of words in the word completion dictionary.

5. The method of claim 1, wherein the word completion dictionary excludes one or more words provided automatically.

6. The method of claim 1, further comprising presenting an option that allows the user to select a method of indicating a word added to the word completion dictionary by the user.

7. A computer program for modifying a word completion dictionary, the computer program comprising:
computer code configured to:
present a word completion dictionary, wherein the word completion dictionary includes a plurality of words that may be selected while entering text in a text entry application; and
present a dictionary editing option, wherein selection of the dictionary editing option allows a user to modify the word completion dictionary.

8. The computer program of claim 7, further comprising computer code configured to allow the user to select a word from the plurality of words in the word completion dictionary.

9. The computer program of claim 8, wherein the dictionary editing option is an option selected from the group consisting of delete, edit, mark, and unmark.

10. The computer program of claim 7, wherein the dictionary editing option adds a new word to the plurality of words in the word completion dictionary.

11. The computer program of claim 7, wherein the word completion dictionary excludes one or more words provided automatically.

12. The computer program of claim 7, further comprising computer code configured to present an option, wherein selection of the option allows the user to select a method of indicating a word added to the word completion dictionary by the user.

13. A device that allows modification of a word completion dictionary, the device comprising:
a word completion dictionary, the word completion dictionary comprising computer code configured to:
present a plurality of words that may be selected while entering text in a text entry application; and
present a dictionary editing option;
a display, wherein the display presents a user interface to the word completion dictionary;
an input interface, the input interface configured to allow a user to select the dictionary editing option, wherein selection of the dictionary editing option allows the user to modify the word completion dictionary;
a memory, wherein the memory stores the word completion dictionary; and
a processor coupled to the memory, the processor configured to execute the word completion dictionary.

14. The device of claim 13, wherein the input interface is further configured to allow the user to select a word from the plurality of words in the word completion dictionary.

15. The device of claim 14, wherein the dictionary editing option is an option selected from the group consisting of delete, edit, mark, and unmark.

16. The device of claim 13, wherein the dictionary editing option adds a new word to the plurality of words in the word completion dictionary.

17. The device of claim 13, wherein the word completion dictionary excludes one or more words provided automatically.

18. The device of claim 13, further comprising computer code configured to present an option, wherein selection of the option allows the user to select a method of indicating a word added to the word completion dictionary by the user.

19. The device of claim 13, wherein the input interface is further configured to allow the user to enter text in the word completion dictionary.

20. A method of providing a word for entry in a text entry application using a word completion dictionary, the method comprising:
recording a sequence of text entries as a user enters a word in a text entry application;
comparing the sequence of text entries to a plurality of words stored in a word completion dictionary, wherein the word completion dictionary includes a dictionary editing option, wherein selection of the dictionary editing option by the user allows the user to modify one or more of the plurality of words stored in the word completion dictionary;
selecting one or more matching words from the word completion dictionary, wherein the matching words have the same sequence of text entries; and
displaying the one or more matching words to the user.

21. The method of claim 20, wherein the dictionary editing option is an option selected from the group consisting of delete, edit, mark, and unmark.

22. The method of claim 20, wherein the dictionary editing option adds a new word to the plurality of words in the word completion dictionary.

23. The method of claim 20, wherein the word completion dictionary excludes one or more words provided automatically.

24. The method of claim 20, further comprising presenting an option that allows the user to select a method of indicating a word added to the word completion dictionary by the user.

25. A computer program for providing a word for entry in a text entry application using a word completion dictionary, the computer program comprising:
computer code configured to:
record a sequence of text entries as a user enters a word in a text entry application;
compare the sequence of text entries to a plurality of words stored in a word completion dictionary, wherein the word completion dictionary includes a dictionary editing option, wherein selection of the dictionary editing option by the user allows the user to modify one or more of the plurality of words stored in the word completion dictionary;
select one or more matching words from the word completion dictionary, wherein the matching words have the same sequence of text entries; and
display the one or more matching words to the user.

26. The computer program of claim 25, wherein the dictionary editing option is an option selected from the group consisting of delete, edit, mark, and unmark.

27. The computer program of claim 25, wherein the dictionary editing option adds a new word to the plurality of words in the word completion dictionary.

28. The computer program of claim 25, wherein the word completion dictionary excludes one or more words provided automatically.

29. The computer program of claim 25, further comprising computer code configured to present an option, wherein selection of the option allows the user to select a method of indicating a word added to the word completion dictionary by the user.

30. A device for providing a word for entry in a text entry application using a word completion dictionary, the device comprising:
a word completion dictionary, the word completion dictionary comprising computer code configured to:
display a plurality of words selectable by a user while entering text in a text entry application; and
allow the user to select a dictionary editing option;
a word completion utility, the word completion utility comprising
computer code configured to:
record a sequence of text entries as the user enters a word in the text entry application;
compare the sequence of text entries to a plurality of words stored in the word completion dictionary;
select one or more matching words from the word completion dictionary, wherein the matching words have the same sequence of text entries; and
display the one or more matching words to the user;
a display, wherein the display presents the user with a view of a user interface to the word completion dictionary and with a view of a user interface to the word completion utility;
an input interface, the input interface configured to:
allow the user to select the dictionary editing option, wherein selection of the dictionary editing option allows the user to modify the word completion dictionary;
allow the user to enter text in the word completion dictionary; and
allow the user to select a matching word from the one or more matching words displayed to the user;
a memory, wherein the memory stores the word completion dictionary and the word completion utility; and
a processor coupled to the memory, the processor configured to execute the word completion dictionary and the word completion utility.

31. The device of claim 30, wherein the input interface is further configured to allow the user to select a word from the plurality of words in the word completion dictionary.

32. The device of claim 31, wherein the dictionary editing option is an option selected from the group consisting of delete, edit, mark, and unmark.

33. The device of claim 30, wherein the dictionary editing option adds a new word to the plurality of words in the word completion dictionary.

34. The device of claim 30, wherein the word completion dictionary excludes one or more words provided automatically.

35. The device of claim 30, further comprising computer code configured to present an option, wherein selection of the option allows the user to select a method of indicating a word added to the word completion dictionary by the user.
